(19) United States
(12) Patent Application Publication
(10) Pub. No.: US 2016/0072890 A1
(43) Pub. Date: Mar. 10, 2016

(54) Frequency, Attitude, and Tendencies Environment (FATE): A modular, scalable, tailorable sensor environment

(71) Applicant: Alexander Thomas Miller, Alexandria, VA (US)

(72) Inventor: Alexander Thomas Miller, Alexandria, VA (US)

(21) Appl. No.: 14/479,289

(22) Filed: Sep. 6, 2014

(51) Int. Cl. H04L 29/08; G01D 9/00; G06F 17/50

(52) U.S. Cl. CPC H04L 67/12; G06F 17/5086; G01D 9/005

(57) ABSTRACT

FATE creates a modular, scalable, and tailorable sensor environment to collect information across four dimensions, three spatial and one temporal. This extends an aware environment that collects data, ranging from minute measurements to major actions, within a FATE. These measurements and data can′ then be fed to cognitive and predictive algorithms so that COLLECTORS can make decisions based on measured actions informed by minute but tangible attributes and characteristics of the USERS or userborne devices within its physical/temporal boundaries.

### WHAT DOES YOUR INVENTION ACCOMPLISH?

FATE interacts with two distinct primary sets of actors, Collectors and Users.

COLLECTORS are the set of actors who implement the FATE systems.

USERS are the set of actors who interact with and within the FATE.

In short FATE accomplishes the following:

The FATE gives COLLECTORS insight into trends based on empirical observations within the FATE. It also provides causal information derived from measurements collected within the FATE from USERS and userborne devices.

The FATE gives USERS the ability to tailor a personal that can be presented to the FATE in order to determine what things or events would be the most desirable.

The second order accomplishment of the FATE is a set of tangible metrics that third-parties can leverage to tailor products or services towards emerging market trends derived by the FATE. This could include App developers writing Application Interfaces to interact with FATE, product developers to curtail or grow distribution channels based on causal data collected by the FATE.

### WHAT ARE THE PARTS OR COMPONENTS?

FATE contains 4 main components:

1. Sensors—These sensors are interconnected by the Panel substrate and collect information in a variety of forms to include: Visible Light to include Facial expression and body language, infrared, Radio Frequency Identification (RFID), Near Field Communication (NFC), Wireless Fidelity (WiFi), Audio to include voice analysis, etc. . . . .

2. Panels—Panels of a FATE instance acting as the electrical and networking substrate for an array of sensors. FATE panels can act individually or in conjunction with other FATE panels to scale up. Panels can be used in a variety of physical configurations including but not limited to: Wall panels, floor panels, ceiling panels, etc. . . . .

3. Processing Units—A processing unit is physically connected to the FATE panels. The processing unit aggregates data collected by the sensors connected to the FATE panel substrate and conducts analysis based on the users preference and interactions within or across the FATE. These include Frequency of Actions, Sentiment and Attitude of users within the FATE, and Tendencies or predictions of actions based on previous actions. Processing units also act as data servers, supplying information to operators or feedback to the FATE for tuning.

4. Users and User-borne devices—Users present the catalyst for a FATE instance. User interaction generates data that is collected by the sensors connected to the panel substrate. Userborne devices can interact with wireless sensors to negotiate data exchange between user devices and the FATE instance through Application Interfaces and information broadcasts.

These components combine to form a single FATE instance. FATE instances can be interconnected via network.

Collectors and third-parties can have effects on a FATE system as they are able to either tune a FATE to focus on a particular type of data or tailor outside technology to interact with the FATE (such as APIs for mobile applications).

### HOW DO THE COMPONENTS CONNECT?

Components connect in two distinct ways:

1. Physical:
Physical System Interaction—The FATE is a tiered system; Sensor clusters are grouped together on panel substrates similar to a LED array in a OLED display, which are interconnected to processing hubs that work together to determine patterns derived from information collected across the sensor clusters. Physically, each sensor in a small cluster could be connected via metal cable, however, panels would need to be connected via high speed interconnects such a fibre-optic or multi-gigabit per second cable connects such as to not bottleneck sensor feedback and collection pipelines. Sensors can also be wirelessly connected to devices that are free-roaming within the FATE. These could include user-borne devices such as smart devices, heads up displays, smart clothes, as well as user operated wireless devices that are extensions of the FATE collecting more information to aggregate with the FATE sensors. Complete FATE instances can be connected to other complate FATE systems over a network.

2. Logical
Logical Data Transfer between sensors, panels, and hubs—The data interconnect is achieved through networking protocols and software data aggregation techniques. These could be hosted on site within a FATE instance or off-shored for data mining and processing needs. Because each FATE system could be configured differently or use different software baselines, an extensible data API will be used to achieve the greatest logical interoperability across different FATE instances.
Outside devices will connect to the fate, logically, through an extensible application layer such as through a front-side app.

### HOW DOES THE INVENTION OPERATE?

The actual sensor tuning, system interaction, data visualization, and data consumption will be done through a standard display technology such as a computer monitor, smart device, or otherwise. The Data represented on this device will be served via the processing unit which is connected to the FATE panels.

The FATE system allows COLLECTORS to measure, mung, and analyze the variables and patterns of USER interactions within the geo-boundaries of a single FATE or aggregate data on specific USERS across various FATE instances. This includes collecting the frequency of actions and sentiment (attitude) of USERS within a geospatial and temporal set of a boundaries and the tendencies of USERS derived from those attributes based on predictive algorithms and statistical models collected from isolated FATEs of a distributed consortium of FATEs.

The attributes of USERS can be based on acoustic, audio, optical (across all spectrums), and seismic (such as foot-traffic analysis and gait recognition), as well as interactions with USER-borne devices such as smart devices, heads-up displays, and other wireless devices through various wireless data transmission standards.

Simply put: FATE will allow COLLECTORS to gauge potential USER actions based on their tendencies and frequency of spot (or one-time) interactions with various independent items and dynamically react, in real time, to those actions. The FATE would give COLLECTORS insight into the causation of a particular set of actions as opposed to the empirical correlation of actions.

Because there are no well implemented methods of collecting repetitive single instance engagements of USER interaction with individual items inside isolated geo-bounded areas, such as stores, it is difficult for COLLECTORS to understand what the majority of users tend to do as opposed to what they are known to do after the fact. For example, point-of-sale data from credit card transactions only give a sample of user actions that can be correlated, as opposed to the total data set of USER actions within an environment which give insight into causation leading up to the events, which could then be used in conjunction with predictive algorithms.

The FATE system connects many sensors via a panel that acts as an electrical and networked substrate to power and collect information from each individual sensor. These sensors can be clustered into various groups that can include multiple panels, groupings of panels, and systems of panels.

This enables system operators to collect a myriad of metrics regarding actions, and information that happen within physically and temporally bounded areas.

These data enable users to make decisions based on usage or information such as:
sentiment of body language or non-obvious physical measurements,
tendencies such as sales, interaction with items, or reactions of pre-determined stimuli
attitude derived from actions including speech analysis
interaction with userborne smart devices such as phones, heads up displays, smart clothes, or other networked objects

### ARE THERE OTHER WAYS TO CONSTRUCT YOUR INVENTION?

FATE is a modular system, construction of the system can be partitioned to various atomic level by scaling the number of sensors in each cluster, scaling the number of clusters on a panel, or scaling the number of panels in an instance.

Similarly the number of interconnecting hubs, processing units, or visual output components can be scaled to the user's desire.

The physical configuration is limited by the physical structures supporting it and the electrical or networking structure interconnecting each of the components.

The smallest stand alone unit in a FATE instance is a Panel and a Processor. The FATE panels can be of different sizes, shapes, and have a myriad of interconnected sensor clusters onboard. The processor is needed to aggregate and process the information coming from the sensors on a panel. A monitor or screen is necessary to view information served by the processor but is assumed to be ubiquitous in nature.

### BRIEF DESCRIPTION OF DRAWINGS

FIG. 1—Sectional view of a single FATE instance depicting a user entering the physical space bounded by the FATE. This user area could be an entire building or facility or a single component of the structure (walls, floors, ceilings, doors, etc. . . . )

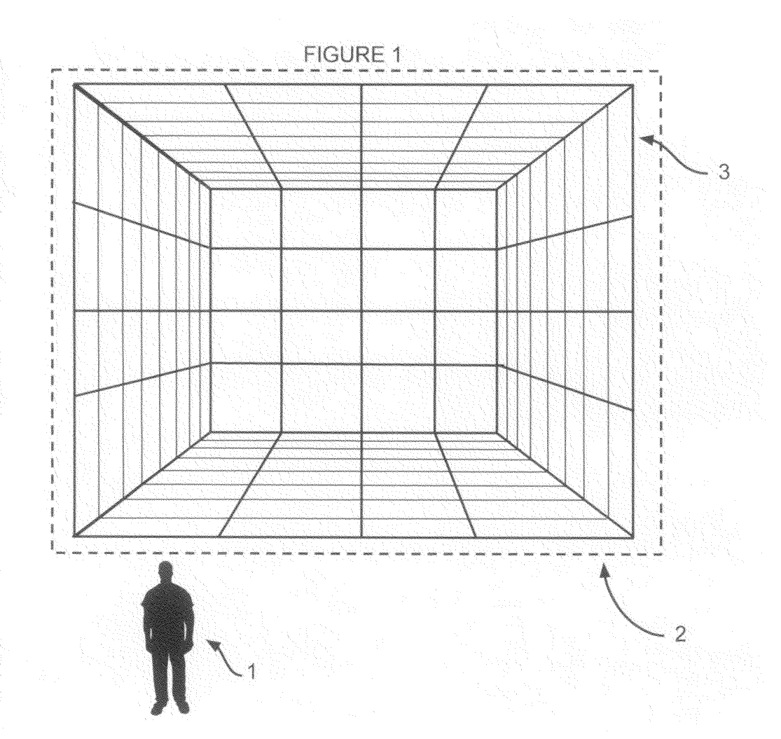

FIG. 2—This figure shows a user inside of a FATE instance interacting with sensors within the FATE. Finally it shows the sensors connected to a processing unit which aggregates each sensor feed per the users requirements. These sensors are interconnected by the Panel substrate and collect information in a variety of forms to include: Visible Light to include Facial expression and body language, infrared, Radio Frequency Identification (RFID), Near Field Communication (NFC), Wireless Fidelity (WiFi), Audio to include voice analysis, etc. . . . . The sensors interact with userborne devices such as smart devices, heads up displays, smart clothes, or other wireless devices.

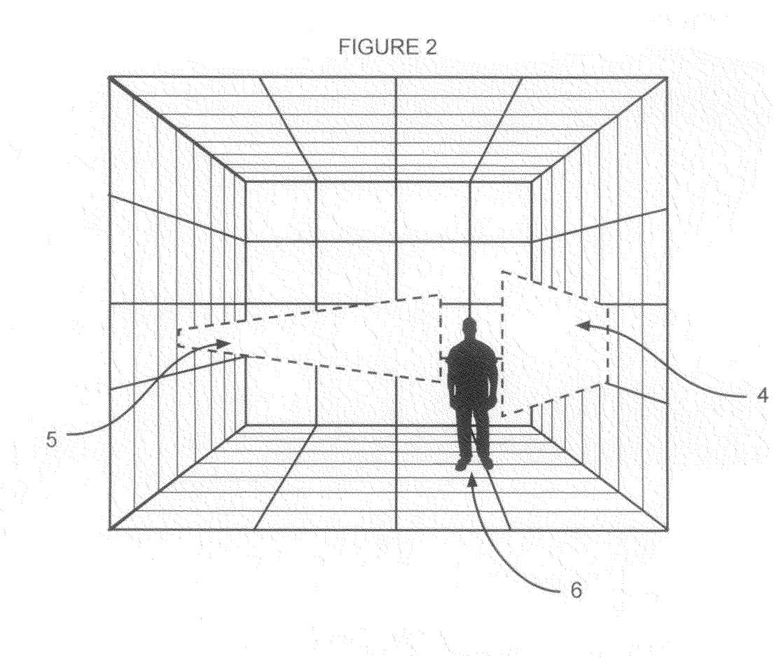

FIG. 3—Exploded sectional view of a cluster of sensors that reside on a FATE panel. Sectional view of a single Panel of a FATE instance acting as the electrical and networking substrate for an array of sensors. FATE panels can act individually or in conjunction with other FATE panels to scale up. Panels can be used in a variety of physical configurations including but not limited to: Wall panels, floor panels, ceiling panels, etc. . . . .

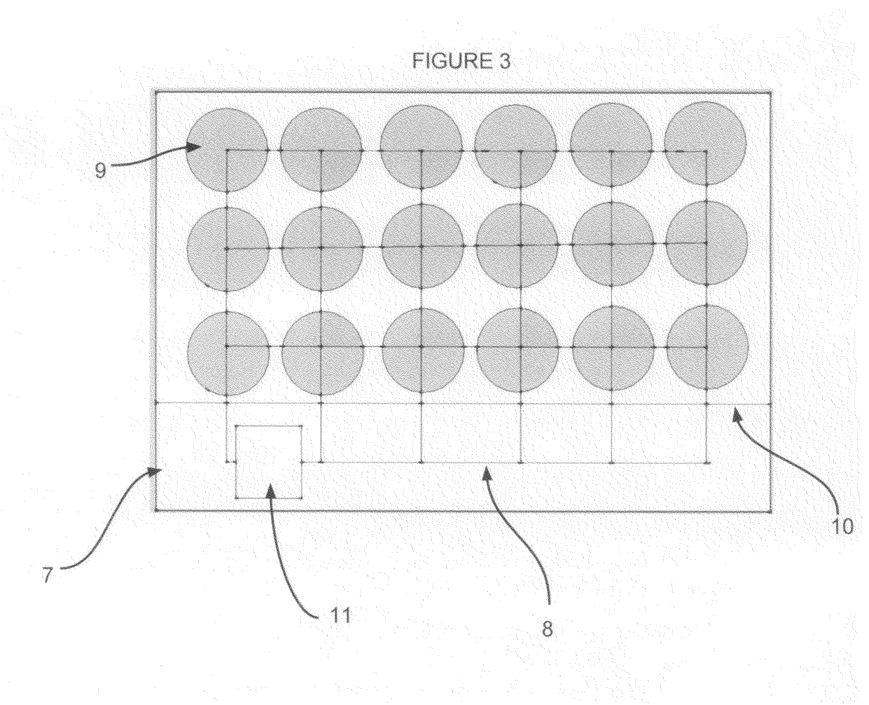

FIG. 4—Shows a single fate panel as it relates to the greater environment. Panels can be interconnected to create a network of panels and environments.

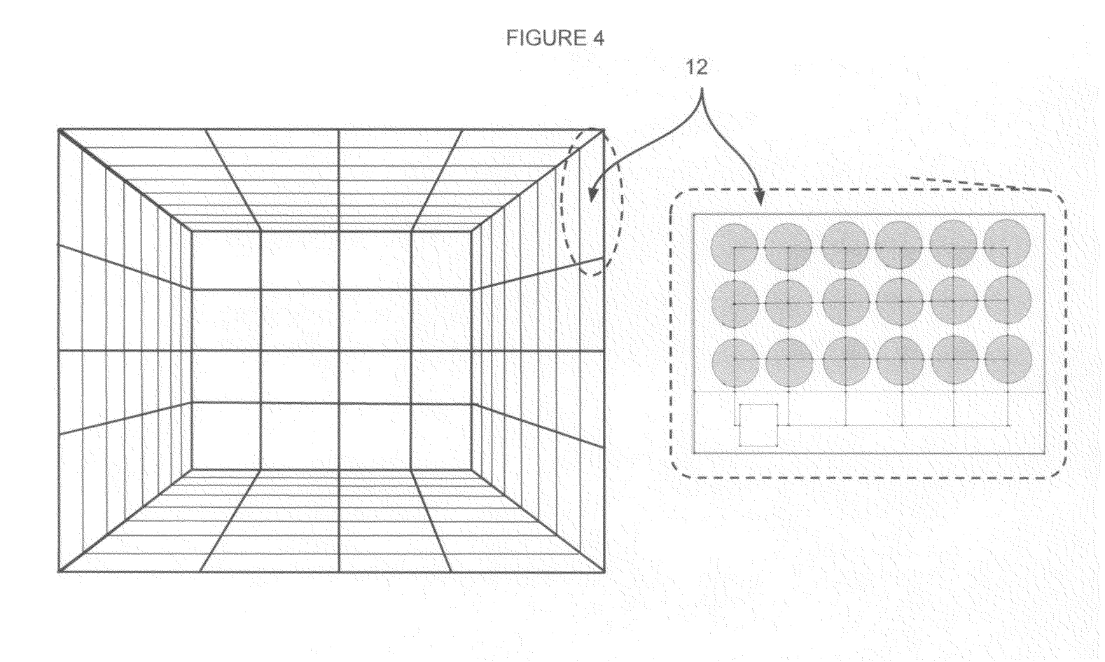

FIG. 5—This shows a 3D view of users within a single environment and multiple FATE panels physically interconnected to provide a larger area to collect information in. Panels can be connected via standard networking mechanisms such as cable, fiber, and high-speed interconnect.

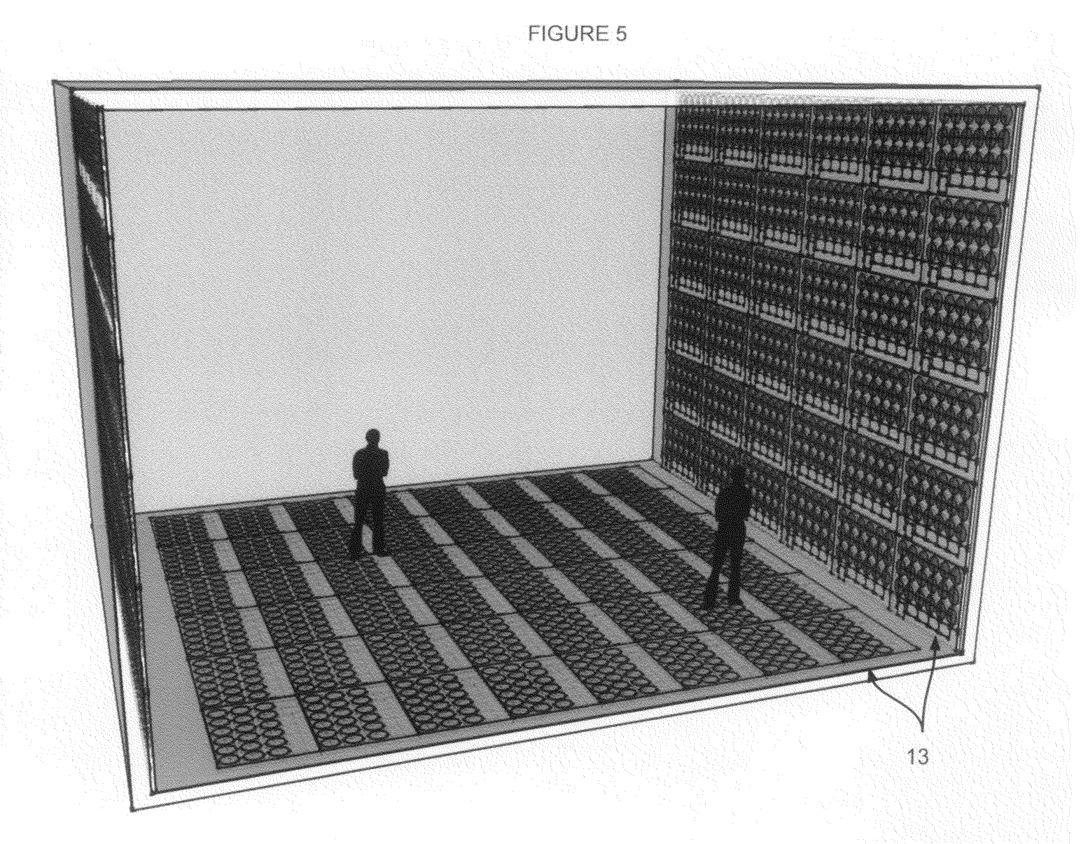

FIG. 6—The network substrate of the FATE could be either wired or wireless depending on the speed necessary to aggregate information and the need to interact with user-borne devices such as smart devices, heads up displays, smart clothes, or other wireless devices.

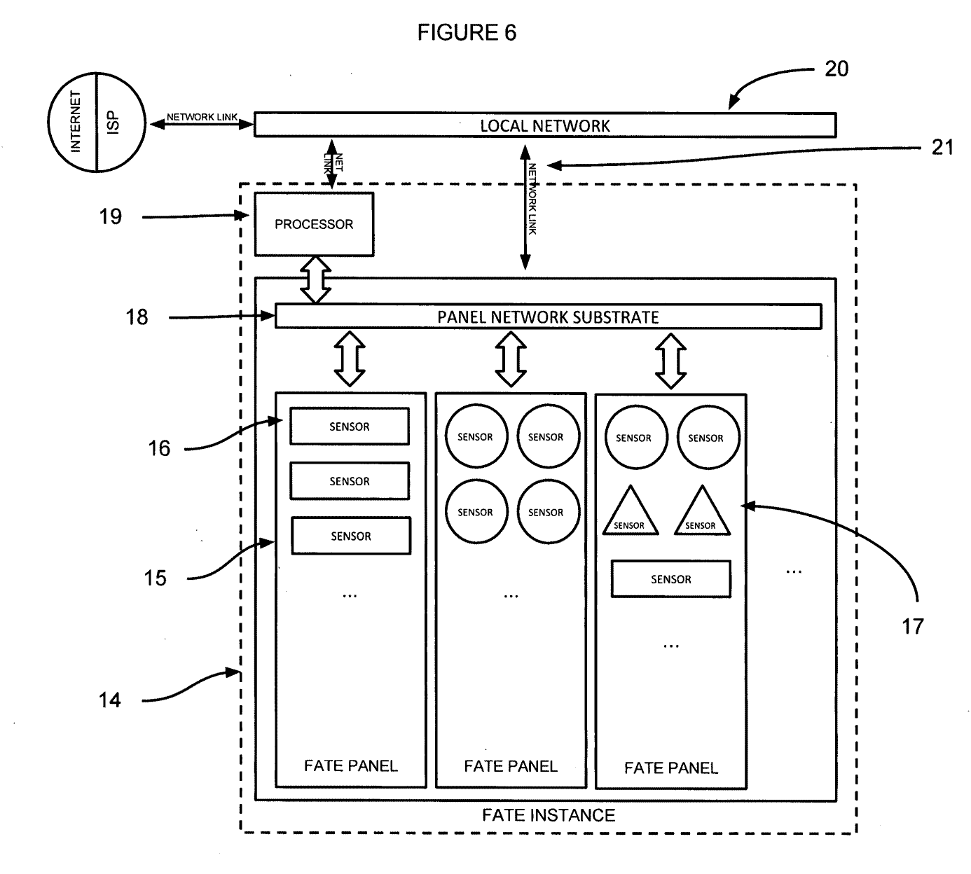

Network View of a processing unit that is physically connected to the FATE panels. The processing unit aggregates data collected by the sensors connected to the FATE panel substrate and conducts analysis based on the users preference and interactions within or across the FATE. These include Frequency of Actions, Sentiment and Attitude of users within the FATE, and Tendencies or predictions of actions based on previous actions.

FIG. 7—Network view of multiple FATE instances connected via networks.

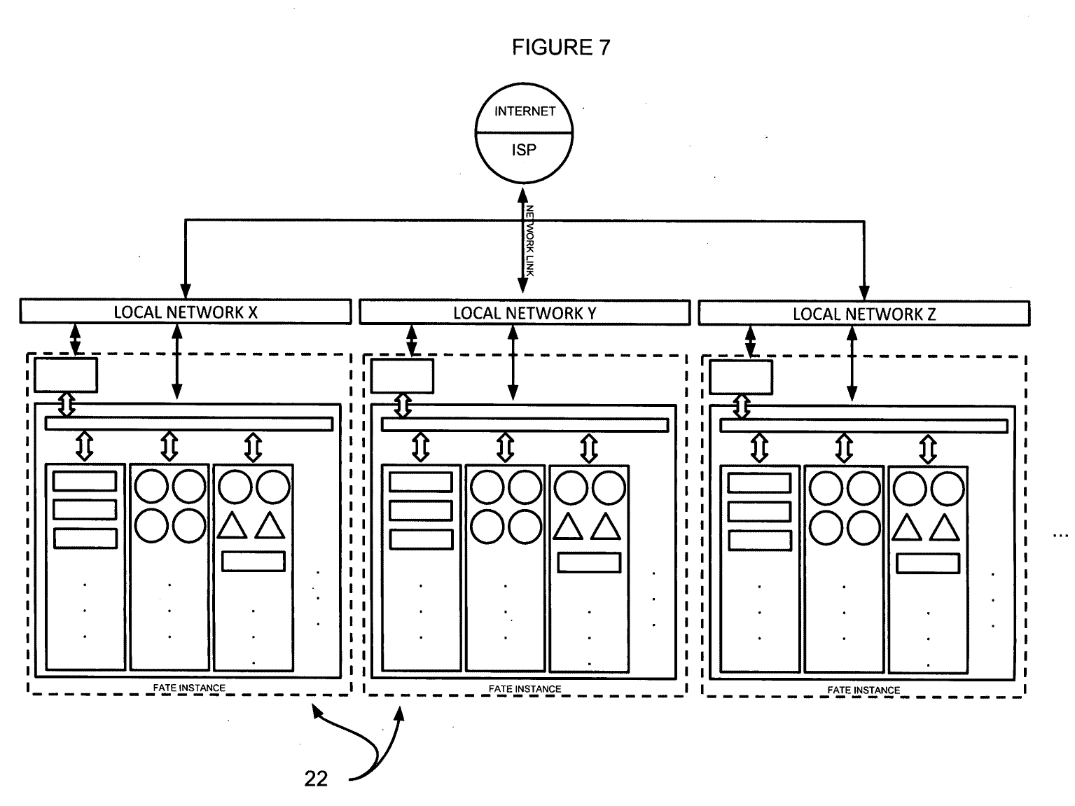

### DESCRIPTION OF FIGURE ITEMS

1. User who will enter FATE instance.
2. Boundary of a Single FATE instance containing panels, processing, and interconnects.
3. Single FATE panel as part of a single Instance within the environment.
4. Single collection pattern for a sensor within a single panel in an instance of FATE.
5. Alternative sensor collection boundary from another panel within the FATE instance.
6. User within the FATE instance interacting with multiple sensors and panels within the FATE instance.
7. Physical boundary of a single panel within a FATE.
8. Physical network substrate within a FATE panel. The network substrate interconnects sensors within a panel and panels within a FATE as well as panels to the local network.
9. Single sensor within a panel. Sensors are not limited to a single design of collection parameter.
10. Panel interconnection network connection.
11. Processing Unit within a single panel of the FATE instance. Processing units can be used to process and correlate data from a single panel, or act as a distributed processing network between panels and FATE instances.
12. Panel consisting of multiple sensors as it relates to a total FATE instance.
13. Multiple panels consisting of multiple sensors interconnected within a FATE instance.
14. Boundary of a physical FATE instance consisting of multiple panels which consist of multiple sensors.
15. Physical boundary of single panel within a single instance of a FATE.
16. Single sensor within a panel of FATE instance.
17. Multiple types of sensors co-existing within a single panel of a FATE instance.
18. Panel network substrate connecting multiple panels within a FATE instance.
19. Aggregate processing capabilities within a single instance of FATE.
20. Local network connection physically connecting to panel network substrates.
21. Physical network connection between FATE panels and the local network.
22. Multiple FATE instances interconnected through their local network and the Internet or Intranet.

### CAN YOUR INVENTION BE USED IN MORE THAN ONE WAY?

The FATE can serve in any use case where a COLLECTOR wants to measure characteristics of a USER to gain insight into causal information augmented by correlated empirical data.

This includes for sales, trends, security, information gathering, law enforcement, etc.

For Example:

1. A supermarket could use a FATE to determine that, while cost is a driving factor for a particular product, users typically spend a measurable amount more time in front of products that are available to sample which leads to higher sales. This could lead a vendor to supply more sample products which could lead to higher sales. (Tendencies)

2. A Police station could use a FATE to determine that under questioning a suspect who exhibit some form of frequent minute action is more susceptible to a particular negotiation technique. (Tendencies/Frequencies)

3. A Mall could implement multiple FATE systems across a food court to determine that customers who stop to eat are more likely to spend money after, and determine what kinds of stores they are more likely to spend money in. (Tendencies/Frequencies)

4. A store could implement a floor panel outside of their store to capture voice and foot traffic analysis of potential customers as they pass a new display or advertisement outside of the store. The resulting sentiment analysis could be used to tune the advertisements to target specific consumer groups. (Attitude/Tendencies/Frequencies)

5. A clothing store could implement a series of FATE panels that interact with user smart clothes and an application on their smart device, linked to a social network profile to automatically determine the best outfit to match a consumer's tailored profile. (Attitude/Tendencies)

6. A store could use a series of FATE ceiling or floor panels located both outside and inside their store to correlate foot traffic and weather data to determine the cause of measurable swings in their product sales. (Frequency/Tendencies)

7. A store could use a FATE system in a cube configuration to create a detailed 3D image of their store at any given point and correlate that data with attitude data captured by the FATE. This could be used to gain insight into customer disposition vs the density of patrons at any given time leading to an understand of certain sales trends such as more customers buying fewer total objects at a higher frequency when the store is more densely populated, as opposed to few customers buying more things less frequently when the store is less densely populated. (Attitude/Frequency/Tendencies)

8. A homeowner could implement FATE as a security system, cataloging visitors and setting the FATE to interrogate visitors when the security settings are appropriately set. (Attitude/Frequency/Tendencies)

9. An establishment could use FATE to capture a 3D video complete with sound, timing artifacts, and details about userborne devices entering and exiting the premises to help in a crime investigation. (Attitude/Frequency/Tendencies)

10. A store could implement a FATE system that interacts with Employee Userborne smart clothes to broadcast the ‘daily color scheme’ and manipulate the fabric luminescens and how the fabric reflects light-waves. (Frequency/Tendencies)
